(19) United States
(12) Patent Application Publication
(10) Pub. No.: US 2026/0360703 A1
(43) Pub. Date: Nov. 12, 2026

(54) METHOD FOR MANUFACTURING ELECTRODE ACTIVE MATERIAL FOR LITHIUM-SULFUR BATTERY

(71) Applicant: NICHIA CORPORATION, Anan-shi (JP)

(72) Inventors: Hideki YOSHIDA, Tokushima shi (JP); Takashi SUGIMOTO, Tokushima shi (JP)

(73) Assignee: NICHIA CORPORATION, Anan-shi (JP)

(21) Appl. No.: 19/470,027

(22) PCT Filed: Mar. 6, 2024
(86) PCT No.: PCT/JP2024/008512

§ 371 Date: Sep. 27, 2025

(30) Foreign Application Priority Data
Mar. 27, 2023 (JP) 2023-050319

(51) Int. Cl. H01M 4/36; H01M 4/02; H01M 4/04; H01M 4/58; H01M 4/587; H01M 10/052

(52) U.S. Cl. CPC H01M 4/364; H01M 4/0471; H01M 4/5815; H01M 4/587; H01M 10/052; H01M 2004/021

(57) ABSTRACT

Provided is a method for manufacturing an electrode active material for a lithium-sulfur battery that can constitute a battery with improved cycle performance. A method for manufacturing an electrode active material for a lithium-sulfur battery includes obtaining a first modified composite material by mixing a composite material including a porous carbon material and sulfur supported on the porous carbon material, a metal source, and a liquid medium, the first modified composite material having a metal compound derived from the metal source being adhered to the first modified composite material, and obtaining a second modified composite material by heat-treating the first modified composite material, the second modified composite material having a metal sulfide being adhered to the second modified composite material.

### TECHNICAL FIELD

The present disclosure relates to a method for manufacturing an electrode active material for a lithium-sulfur battery.

### BACKGROUND ART

A lithium-sulfur battery is a secondary battery having a high energy density per unit mass and uses, for example, a mesoporous carbon-sulfur composite in which sulfur is disposed in mesopores. A lithium-sulfur battery, known to be lighter than a lithium-ion battery, is expected to be mounted in, for example, large-scale power equipment applications such as electric vehicles and aviation applications such as drones. These applications require improvement in a cycle capacity retention rate, improvement in charge/discharge capacity, and the like.

In relation to the above, for example, JP 2021-531228 T proposes a positive electrode material containing iron sulfide that adsorbs lithium polysulfide.

### SUMMARY OF INVENTION

### Technical Problem

An object of an aspect of the present disclosure is to provide a method for manufacturing an electrode active material for a lithium-sulfur battery that can constitute a battery with improved cycle performance.

### Solution to Problem

A first aspect is a method for manufacturing an electrode active material for a lithium-sulfur battery, the method including: obtaining a first modified composite material by mixing a composite material including a porous carbon material and sulfur supported on the porous carbon material, a metal source, and a liquid medium, the first modified composite material having a metal compound derived from the metal source being adhered to the first modified composite material; and obtaining a second modified composite material by heat-treating the first modified composite material, the second modified composite material having a metal sulfide being adhered to the second modified composite material. The metal source includes at least one specific metal selected from the group consisting of Ti, V, Mn, Fe, Co, Ni, Cu, Zn, Ge, Zr, In, Sn, Nb, Mo, Ta, and W.

In one aspect, a method for manufacturing an electrode active material for a lithium-sulfur battery may include: obtaining a first modified composite material by heat-treating a mixture containing a composite material including a porous carbon material and sulfur supported on the porous carbon material, a metal source, and a liquid medium under pressure to deposit a metal compound derived from the metal source on a surface of the composite material, the first modified composite material having the metal compound being adhered to the first modified composite material; and obtaining a second modified composite material by heat-treating the first modified composite material, the second modified composite material having a metal sulfide derived from the metal source being adhered to the second modified composite material.

In one aspect, a method for manufacturing an electrode active material for a lithium-sulfur battery may include: obtaining a first modified composite material by adjusting a pH of a mixture containing a composite material including a porous carbon material and sulfur supported on the porous carbon material, a metal source, and a liquid medium to deposit a metal compound derived from the metal source on a surface of the composite material, the first modified composite material having the metal compound being adhered to the first modified composite material; and obtaining a second modified composite material by heat-treating the first modified composite material, the second modified composite material having a metal sulfide derived from the metal source being adhered to the second modified composite material.

In one aspect, a method for manufacturing an electrode active material for a lithium-sulfur battery may include: obtaining a first modified composite material by adding a sulfur source to a mixture containing a composite material including a porous carbon material and sulfur supported on the porous carbon material, a metal source, and a liquid medium to deposit a metal compound derived from the metal source on a surface of the composite material, the first modified composite material having the metal compound being adhered to the first modified composite material; and obtaining a second modified composite material by heat-treating the first modified composite material, the second modified composite material having a metal sulfide derived from the metal source being adhered to the second modified composite material.

A second aspect is a positive electrode active material for a lithium-sulfur battery including a composite material including a porous carbon material and sulfur supported on the porous carbon material, and a metal sulfide including a specific metal. In the positive electrode active material for a lithium-sulfur battery, a ratio of: a mass ratio of a specific metal to a total amount of carbon, sulfur, oxygen, nitrogen, and the specific metal in the vicinity of a surface of the positive electrode active material for a lithium-sulfur battery as measured by energy dispersive spectroscopy; to a content ratio of the specific metal on a mass basis in the positive electrode active material for a lithium-sulfur battery as measured by inductively coupled plasma emission spectrometry is 0.3 or more. The specific metal includes at least one selected from the group consisting of Ti, V, Mn, Fe, Co, Ni, Cu, Zn, Ge, Zr, In, Sn, Nb, Mo, Ta, and W.

### Advantageous Effects of Invention

According to an aspect of the present disclosure, a method for manufacturing an electrode active material for a lithium-sulfur battery that can constitute a battery with improved cycle performance can be provided.

### BRIEF DESCRIPTION OF DRAWINGS

FIG. 1 is a diagram illustrating an example of an X-ray diffraction spectrum of an electrode active material according to Example 1.

FIG. 2 is a diagram illustrating an example of an X-ray diffraction spectrum of an electrode active material according to Example 2.

FIG. 3 is a diagram illustrating an example of an X-ray diffraction spectrum of an electrode active material according to Example 3.

FIG. 4 is a diagram illustrating an example of an X-ray diffraction spectrum of an electrode active material according to Example 4.

FIG. 5 is a diagram illustrating an example of an X-ray diffraction spectrum of an electrode active material according to Comparative Example 1.

FIG. 6 is a diagram illustrating an example of an X-ray diffraction spectrum of an electrode active material according to Comparative Example 2.

FIG. 7 is a diagram illustrating an example of a scanning electron microscope image of an electrode active material according to Example 1.

### DESCRIPTION OF EMBODIMENTS

In the present specification, the word “step” herein includes not only an independent step, but also a step that cannot be clearly distinguished from another step if the anticipated purpose of the step is achieved. Note that, as for a content of each component in a composition, when a plurality of substances applicable to each component in the composition are present, it means a total amount of the plurality of substances present in the composition, unless otherwise specified. Furthermore, with respect to an upper limit and a lower limit of numerical ranges described herein, the numerical values exemplified as the numerical range can be freely selected and combined. Embodiments of the present invention are described below in detail. However, the embodiments described below are merely examples of an electrode active material for a lithium-sulfur battery and a manufacturing method thereof for embodying the technical concept of the present invention, and the present invention is not limited to the electrode active material for a lithium-sulfur battery and the manufacturing method thereof to be described below.

Method for Manufacturing Electrode Active Material for Lithium-sulfur Battery A method for manufacturing an electrode active material for a lithium-sulfur battery (hereinafter, also simply referred to as “manufacturing method”) includes a first modification step of mixing a composite material including a porous carbon material and sulfur supported on the porous carbon material, a metal source, and a liquid medium to obtain a first modified composite material to which a metal compound derived from the metal source is adhered, and a second modification step of heat-treating the first modified composite material to obtain a second modified composite material to which a metal sulfide derived from the metal source is adhered. In addition to the first modification step and the second modification step, the manufacturing method may further include other steps, as necessary.

The metal compound containing a metal derived from the metal source is deposited on the surface of a composite material containing a sulfur-supported porous carbon material in the presence of a liquid medium, thereby obtaining the first modified composite material, which is a composite material in which the metal compound is uniformly adhered to the surface. The obtained first modified composite material is subjected to heat treatment to obtain the second modified composite material in which the metal sulfide derived from the metal source is uniformly adhered to the surface of the composite material. The metal sulfide disposed on the surface can suppress the outflow of lithium polysulfide generated during discharge of the lithium-sulfur battery from the porous carbon material. Thus, the cycle performance of the lithium-sulfur battery is improved. This can be assumed to be because, for example, the metal sulfide present on the surface of the composite material can suppress the passage of an electrolytic solution while allowing the passage of lithium ions.

In the first modification step, the composite material, the metal source, and the liquid medium are mixed to obtain a mixture, and the first modified composite material in which the metal compound derived from the metal source is deposited on the surface of the composite material is obtained. The composite material to be used for preparing the mixture may be prepared through taking over or the like, or a desired composite material may be prepared by a known method. The composite material can be prepared, for example, by heat-treating a mixture of the porous carbon material and sulfur.

The porous carbon material used for preparation of the composite material may have a substantially spherical shape or the like. The porous carbon material may also have a substantially spherical shape in which fibrous carbon such as carbon nanotubes is aggregated. A volume mean particle size of the porous carbon material, for example, may be in a range from 0.5 μm to 50 μm, may be 1 μm or more, 1.5 μm or more, or 2 μm or more, and may be 40 μm or less, 30 μm or less, 15 μm or less, 10 μm or less, or 5 μm or less. When the volume mean particle size of the porous carbon material is within the above-described range, there is a tendency that an electrode with less coating unevenness can be produced. The volume mean particle size D50 of the porous carbon material is measured as a particle size corresponding to a volume accumulation of 50% from a small size side in a volume-based particle size distribution. The volume-based particle size distribution is measured by a laser diffraction particle size distribution measuring device.

The porous carbon material may have an aspect ratio (major axis/minor axis) in a range from 1 to 3, for example. The aspect ratio may be preferably 1.05 or more, and may be preferably 2 or less, 1.5 or less, or 1.2 or less. The major axis and the minor axis of the porous carbon material are measured by a method for calculating the lengths of the major axis and the minor axis from an image obtained by an optical microscope, an electron microscope, or the like, or by using an image type particle size distribution measuring device. Specifically, for example, the volume mean particle size D50 is measured with a laser diffraction particle size distribution measuring device, 30 to 50 porous carbon material particles each having a particle size, which is an arithmetic mean value of the major axis and the minor axis measured from a scanning electron microscopic (SEM) image, in a range from 0.1 times to 1.5 times D50 are arbitrarily selected, the aspect ratio of each of the particles is calculated, and the aspect ratio of the porous carbon material is calculated as an arithmetic mean value of the calculated values. The aspect ratio is determined in accordance with the Japanese Industrial Standard (JIS Z8900-1:2008) by measuring a maximum major axis of the particle and a minor axe, which is a width perpendicular to the maximum major axis, calculating a ratio of the major axe to the minor axe, and calculating the arithmetic mean value of the ratios. For example, automatic analysis can be performed using software such as Image J.

The peak pore size of the porous carbon material, for example, may be in a range from 0.5 nm to 10 nm, may be 1.5 nm or more, 2.0 nm or more, or 2.5 nm or more, and may be 8 nm or less, 6 nm or less, 4 nm or less, or 3 nm or less. When the peak pore size of the porous carbon material is within the above-described range, there is a tendency that a reaction between the metal source and the sulfur is appropriately suppressed and a decrease in the charge/discharge capacity of the lithium-sulfur battery can be more effectively suppressed. The peak pore size means a pore size showing a maximum peak in a pore distribution curve obtained by a quenched solid density functional method (QSDFT method) from a nitrogen adsorption isotherm obtained by nitrogen gas adsorption-desorption measurement.

The specific surface area of the porous carbon material, for example, may be 1000 m²/g or more, or may be preferably, 1500 m²/g or more, 2000 m²/g or more, or 2500 m²/g or more. The specific surface area may be, for example, 3500 m²/g or less, 3300 m²/g or less, or 3000 m²/g or less. The specific surface area of the porous carbon material is measured by a Brunauer Emmett Teller (BET) method based on a BET theory.

Specifically, for example, the specific surface area is measured by a multipoint method using nitrogen gas.

The pore volume of the porous carbon material, for example, may be in a range from 0.8 ml/g to 4 ml/g, may be 0.9 ml/g or more, 1.0 ml/g or more, or 1.2 ml/g or more, and may be 3 ml/g or less, 2.5 ml/g or less, 2.3 ml/g or less, 2 ml/g or less, or 1.5 ml/g or less. In particular, the pore volume of pores having a diameter in a range from 0.5 nm to 4.0 nm is preferably within the above-described range. When the pore volume of the porous carbon material is within the above-described range, since the pores of the porous carbon material can be filled with a large amount of sulfur, the energy density of the lithium-sulfur battery tends to be increased. The pore volume of the porous carbon material is measured by, for example, nitrogen gas adsorption-desorption measurement.

The content ratio of carbon in the porous carbon material, for example, may be 80 mass % or more or may be preferably 90 mass % or more or 95 mass % or more, or the porous carbon material may be substantially composed of only carbon. The term “substantially” is intended not to exclude other elements that are inevitably mixed.

Specific examples of the porous carbon material include carbon nanotubes, graphene, and a carbon material obtained by carbonizing and activating a compound containing a resin, a petroleum pitch, or a plant as a raw material. The porous carbon material may contain at least activated carbon. One type of porous carbon material may be used alone, or two or more types may be used in combination.

The composite material includes sulfur supported on the porous carbon material. At least a part of the sulfur may be disposed in the pores of the porous carbon material, or may be disposed on the surface of the porous carbon material. The purity of the sulfur supported on the porous carbon material, for example, may be 50 mass % or more or 90 mass % or more, or may be 100 mass % or less.

By using the porous carbon material in which the sulfur is disposed on the surface as the composite material, the metal sulfide can be more uniformly disposed on the surface of the composite material, and the outflow of the lithium polysulfide generated during discharge from the porous carbon material can be more effectively suppressed.

The content of the sulfur in the composite material, for example, may be in a range from 100 mass % to 500 mass %, and may be preferably 120 mass % or more, 140 mass % or more, 150 mass % or more, or 200 mass % or more with respect to the porous carbon material. The content of the sulfur in the composite material may be preferably 300 mass % or less or 200 mass % or less.

The composite material can be prepared by heat-treating a mixture containing the porous carbon material and sulfur. In addition to the porous carbon material and sulfur, the mixture may further contain a compound containing phosphorus, boron, nitrogen, or the like, a transition metal, a polymer compound, or the like, as necessary. The heat treatment of the mixture can be performed, for example, in a sealed container at a heat treatment temperature in a range from 100 °C to 450 °C. The temperature of the heat treatment may be 120 °C or more or 400 °C or less. The pressure during the heat treatment may be atmospheric pressure or more, and may be 15 MPa or less as gauge pressure. The time of the heat treatment, for example, may be in a range from 1 hour to 72 hours, or may be 1.5 hours or more or 36 hours or less.

The content of the composite material in the mixture containing the composite material, the metal source, and the liquid medium in the first modification step, for example, may be in a range from 1 mass % to 70 mass %, may be 5 mass % or more, 7 mass % or more, 10 mass % or more, 20 mass % or more, or 30 mass % or more, and may be 50 mass % or less or 40 mass % or less, with respect to the total mass of the mixture. When the content of the composite material is within the above-described range, a wet dispersion treatment can be more efficiently performed.

The metal contained in the metal source constituting the mixture may contain at least one specific metal selected from the group consisting of titanium (Ti), vanadium (V), manganese (Mn), iron (Fe), cobalt (Co), nickel (Ni), copper (Cu), zinc (Zn), germanium (Ge), zirconium (Zr), indium (In), tin (Sn), niobium (Nb), molybdenum (Mo), tantalum (Ta), and tungsten (W), and may contain at least Zn. It is assumed that the specific metal reacts with sulfur to form a metal sulfide that allows lithium ions to pass therethrough and does not allow an electrolytic solution to pass therethrough. The metal source may contain a simple substance of a specific metal, an alloy, a compound containing a specific metal, or the like. Examples of the compound containing the specific metal include metal salts such as sulfates, nitrates, oxalates, phosphates, and borates; oxides, nitrides, carbides, borides, sulfides, phosphides, composite oxides, and composite oxynitrides. The purity of the compound containing the specific metal used as the metal source may be, for example, 30 mass % or more, 60 mass % or more, or 90 mass % or more. The purity of the compound containing the specific metal may be, for example, less than 100 mass %.

The metal source may be a substance soluble in the liquid medium to be described below. The modified composite material can be more efficiently obtained by using a metal source soluble in the liquid medium. The term “soluble in the liquid medium” as used herein means that the solubility in 100 g of the liquid medium at room temperature (for example, 25 °C) or the temperature of heat treatment is 0.01 g or more. The solubility may be 0.02 g or more.

The content of the metal source in the mixture containing the composite material, the metal source, and the liquid medium, for example, may be in a range from 0.1 mass % to 50 mass %, may be 1 mass % or more, 1.5 mass % or more, 2 mass % or more, or 3 mass % or more, and may be 30 mass % or less, 20 mass % or less, 10 mass % or less, 5 mass % or less, or 4 mass % or less, with respect to the total mass of the mixture. When the content of the metal source is within the above-described range, the metal source can be uniformly added to the composite material.

In the mixture, the mass ratio of the content of the metal source to the content of the composite material, for example, may be in a range from 0.1 mass % to 20 mass %, may be preferably 0.5 mass % or more, 1 mass % or more, 2 mass % or more, or 5 mass % or more, and may be preferably 18 mass % or less, 15 mass % or less, 12 mass % or less, or 10 mass % or less. When the mass ratio of the metal source to the composite material is within the above-described range, there is a tendency that a positive electrode material for a lithium-sulfur battery can be produced while suppressing a decrease in the energy density of the lithium-sulfur battery.

The liquid medium constituting the mixture containing the composite material, the metal source, and the liquid medium may be a substance that can dissolve at least a part of the metal source, and may contain at least water. When the liquid medium contains water, the content of water in the liquid medium may be 20 mass % or more, 40 mass % or more, or 60 mass % or more with respect to the total mass of the liquid medium. In addition, the content of water in the liquid medium may be 100 mass % or less, or less than 100 mass %. The liquid medium may contain a liquid medium other than water. Examples of the liquid medium other than water include water-soluble organic solvents such as ethanol.

The content of the liquid medium in the mixture containing the composite material, the metal source, and the liquid medium, for example, may be in a range from 10 mass % to 99 mass %, may be 20 mass % or more, 30 mass % or more, 50 mass % or more, or 60 mass % or more, and may be 95 mass % or less, 90 mass % or less, 80 mass % or less, or 70 mass % or less, with respect to the total mass of the mixture. When the content of the liquid medium is within the above-described range, the wet dispersion treatment can be more efficiently performed.

The pH of the mixture containing the composite material, the metal source, and the liquid medium, for example, may be in a range from 1 to 14, may be preferably 1.5 or more or 2 or more, and may be preferably 13.5 or less, 7 or less, or 5 or less. The pH of the mixture may be set depending on the type of metal source.

The mixture is obtained by mixing the composite material, the metal source, and the liquid medium. The mixing method for obtaining the mixture may be appropriately selected from commonly used wet dispersion processing methods. Specific examples of the mixing method include a method using a propeller type stirrer, a method using beads, and a method using a homogenizer. The temperature during mixing may be in a range from 0 °C to 100 °C, for example. The mixing time may be in a range from 1 minutes to 72 hours, for example.

In the first modification step, the first modified composite material in which the metal compound derived from the metal source is deposited on the surface is obtained. Examples of the metal compound to be deposited include a metal oxide, a metal hydroxide, a metal sulfide, a metal phosphate, and a metal borate. Examples of the method for depositing the metal compound include heat treatment of the mixture, pH adjustment of the liquid medium constituting the mixture, removal of the liquid medium from the mixture, and adjustment of the ion concentration of ions constituting the metal compound to be deposited.

In one aspect, the manufacturing method may be a first manufacturing method in which the first modification step includes a first heat treatment step of heat-treating the mixture. In the first heat treatment step, the obtained mixture may be heat-treated under a sealed condition and in a pressurized state. This can obtain the first modified composite material. By reacting the sulfur contained in the composite material with the metal source in the presence of the liquid medium, for example, a deposit containing a metal sulfide is deposited on the surface of the composite material to form the first modified composite material. In addition, by depositing the metal sulfide in the liquid medium, the metal sulfide can be uniformly deposited on the surface of the composite material.

The first heat treatment step may be performed under a sealed condition. Specifically, the first heat treatment step can be performed by heating the mixture in a closed container having pressure resistance. The pressurization condition in the first heat treatment step may be the vapor pressure of the liquid medium in the first heat treatment step. For example, when the liquid medium is water and the temperature of the first heat treatment step is 230 °C, the absolute pressure is 2.8 MPa. Other pressurization conditions, for example, may be in a range from 2.0 MPa to 15 MPa, or may be 4.7 MPa or more or 7.4 MPa or less.

The temperature of the first heat treatment step may be, for example, a temperature equal to or more than the boiling point of the liquid medium. The first heat treatment step may include a temperature raising step of raising the temperature of the mixture to a predetermined temperature and a maintaining step of maintaining the predetermined temperature for a predetermined time. The temperature rising rate in the temperature raising step may be adjusted so that the maximum temperature during the temperature rise does not exceed a target temperature, and may be in a range from 1 °C/min to 20 °C/min, for example. The predetermined heat treatment temperature in the first heat treatment step, for example, may be in a range from 120 °C to 300 °C, may be 150 °C or more or 200 °C or more, and may be 270 °C or less or 250 °C or less. The predetermined time in the maintaining step may be, for example, 30 minutes or more, 1 hour or more, or 3 hours or more. The predetermined time in the maintaining step may be, for example, 72 hours or less, 48 hours or less, or 24 hours or less. The predetermined heat treatment time in the maintaining step is set such that a time point at which the temperature set in the above-described temperature range is reached is set as a start time and a time point at which an operation for lowering the temperature is performed is set as an end time.

The atmosphere of the first heat treatment step may be, for example, any one of an air atmosphere, a nitrogen atmosphere, an argon atmosphere, and the like.

The first heat treatment step may include, subsequent to the above-described maintaining step, a cooling step of lowering the temperature of a dispersion liquid containing the obtained first modified composite material. The cooling step starts when the operation for lowering the temperature is performed and ends when the temperature is lowered to 50 °C or less. The temperature lowering rate may be in a range from 1 °C/min to 10 °C/min, for example.

The first manufacturing method may further include a separation step of separating the obtained first modified composite material from the mixture, and may further include a purification step, as necessary. In the separation step, for example, the first modified composite material may be taken out by subjecting the mixture containing the first modified composite material to solid-liquid separation. In the purification step, the first modified composite material may be washed with pure water or the like. The resultant first modified composite material may be dried by, for example, heat drying, vacuum degassing, air drying, or a combination thereof.

The first manufacturing method includes the second modification step of heat-treating the first modified composite material to obtain a second modified composite material in which a metal sulfide derived from the metal source is adhered to a composite material. In the second modification step, by subjecting the first modified composite material, which is a composite material to which the metal sulfide is adhered, to a reheating treatment, a composite material to which the metal sulfide is adhered on the surface thereof can be obtained as a second modified composite material in which the state of sulfur is more stable. The metal sulfide contained in the second modified composite material may be a metal sulfide containing a specific metal, and may contain at least a zinc sulfide. The heat treatment in the second modification step of the first manufacturing method may include removing at least a part of the liquid medium adhering to the first modified composite material to obtain a dried product.

The heat treatment in the second modification step of the first manufacturing method may include a temperature raising step of raising the temperature of the first modified composite material to a predetermined temperature and a maintaining step of maintaining the predetermined temperature for a predetermined time. The temperature rising rate in the temperature raising step may be in a range from 1 °C/min to 20 °C/min, for example. The predetermined heat treatment temperature in the heat treatment, for example, may be in a range from 100 °C to 450 °C, may be 120 °C or more or 150 °C or more, and may be 430 °C or less or 400 °C or less. The predetermined time in the maintaining step may be, for example, 30 minutes or more, 1 hour or more, or 3 hours or more. The predetermined time in the maintaining step may be, for example, 72 hours or less, 48 hours or less, or 24 hours or less. The predetermined heat treatment time in the maintaining step is set such that a time point at which the temperature set in the above-described temperature range is reached is set as a start time and a time point at which an operation for lowering the temperature is performed is set as an end time. The atmosphere of the heat treatment may be, for example, any one of an air atmosphere, a nitrogen atmosphere, an argon atmosphere, and the like.

The heat treatment in the second modification step may include, subsequent to the above-described maintaining step, a cooling step of lowering the temperature of the first modified composite material. The cooling step starts when the operation for lowering the temperature is performed and ends when the temperature is lowered to 50 °C or less. The temperature lowering rate may be in a range from 1 °C/min to 10 °C/min, for example.

In one aspect, the manufacturing method may be a second manufacturing method in which the first modification step includes a pH adjustment step of adjusting the pH of the liquid medium constituting the mixture. By adjusting the pH of the liquid medium, the metal compound whose solubility has been lowered is deposited on the surface of the composite material to obtain a first modified composite material that is a composite material in which the metal compound is adhered to the surface. By depositing the metal compound in the liquid medium, the metal compound can be uniformly deposited on the surface of the composite material. Examples of the metal compound deposited in the pH adjustment step include a metal hydroxide, a metal oxide, a metal sulfide, a metal phosphate, and a metal borate, and the metal compound may contain at least one selected from the group consisting of these compounds.

In the pH adjustment step, a metal compound containing a metal derived from the metal source may be deposited by adjusting the pH of the liquid medium. Specifically, for example, a basic compound or an acidic compound may be added to the mixture to adjust the pH of the liquid medium. Examples of the basic compound used for pH adjustment include hydroxide salts such as hydroxides of alkali metals and hydroxides of alkaline earth metals, and aqueous ammonia solution. Examples of the acidic compound include nitric acid, sulfuric acid, phosphoric acid, and boric acid. The pH adjustment range in the pH adjustment step, for example, may be in a range from 2 to 14, or may be preferably 2.5 or more or 13.5 or less. In the pH adjustment step, for example, the pH of the liquid medium may be increased, preferably by 1 or more or 2 or more. The increase in pH may be 12 or less. In addition, in the pH adjustment step, for example, the pH of the liquid medium may be lowered, and may be preferably lowered by 1 or more or 2 or more. The decrease in pH may be 14 or less.

After the pH of the liquid medium is adjusted, a deposition step of depositing the metal compound may be included. In the deposition step, the metal compound may be deposited while stirring the mixture, or the metal compound may be deposited in a stationary state. A temperature in the deposition step, for example, may be in a range from 0 °C to 100 °C, or may be preferably 10 °C or more or 90 °C or less. A deposition time in the deposition step, for example, may be in a range from 1 minute to 72 hours, or may be preferably 5 minutes or more or 48 hours or less.

The second manufacturing method may further include a separation step of separating the obtained first modified composite material from the mixture, and may further include a purification step, as necessary. In the separation step, for example, the first modified composite material may be taken out by subjecting the mixture containing the first modified composite material to solid-liquid separation. In the purification step, the first modified composite material may be washed with pure water or the like. The resultant first modified composite material may be dried by, for example, heat drying, vacuum degassing, air drying, or a combination thereof.

The second manufacturing method includes a second modification step of heat-treating the first modified composite material to obtain a second modified composite material, in which a metal sulfide derived from the metal source is adhered to a composite material. In the second modification step, by heat-treating the first modified composite material which is the composite material to which the metal compound is adhered, for example, the metal compound and sulfur contained in the composite material react with each other to generate the metal sulfide, and the second modified composite material that is the composite material to which the metal sulfide is adhered is obtained. The metal sulfide contained in the second modified composite material may be a metal sulfide containing a specific metal, and may contain at least a zinc sulfide. The heat treatment in the second modification step of the second manufacturing method may include removing at least a part of the liquid medium adhering to the first modified composite material to obtain a dried product.

The heat treatment in the second modification step of the second manufacturing method may include a temperature raising step of raising the temperature of the first modified composite material to a predetermined temperature and a maintaining step of maintaining the predetermined temperature for a predetermined time. The temperature rising rate in the temperature raising step may be in a range from 1 °C/min to 20 °C/min, for example. The predetermined heat treatment temperature in the heat treatment, for example, may be in a range from 50 °C to 450 °C, may be 100 °C or more or 150 °C or more, and may be 400 °C or less or 350 °C or less. The predetermined time in the maintaining step may be, for example, 30 minutes or more, 1 hour or more, or 3 hours or more. The predetermined time in the maintaining step may be, for example, 72 hours or less, 48 hours or less, or 24 hours or less. The predetermined heat treatment time in the maintaining step is set such that a time point at which the temperature set in the above-described temperature range is reached is set as a start time and a time point at which an operation for lowering the temperature is performed is set as an end time. The atmosphere of the heat treatment may be, for example, any one of an air atmosphere, a nitrogen atmosphere, an argon atmosphere, and the like.

The heat treatment in the second modification step may include, subsequent to the above-described maintaining step, a cooling step of lowering the temperature of the first modified composite material. The cooling step starts when the operation for lowering the temperature is performed and ends when the temperature is lowered to 50 °C or less. The temperature lowering rate may be in a range from 1 °C/min to 10 °C/min, for example.

In one aspect, the manufacturing method may be a third manufacturing method in which the first modification step includes a sulfur source addition step of adding a sulfur source to the mixture. The metal compound whose solubility is lowered by adding the sulfur source to the mixture is deposited on the surface of the composite material to obtain a first modified composite material that is a composite material in which the metal compound is adhered to the surface. By depositing the metal compound in the liquid medium, the metal compound can be uniformly deposited on the surface of the composite material. Examples of the metal compound deposited in the sulfur source addition step include a metal sulfide, a metal hydroxide, and a metal oxide, and the metal compound may contain at least one selected from the group consisting of compounds.

The sulfur source added to the mixture may be, for example, a compound that can generate sulfide ions. Specific examples of the sulfur source include hydrogen sulfide, carbon disulfide, silicon disulfide, nitrogen sulfide, phosphorus sulfide, and arsenic sulfide. The amount of the sulfur source added may be, for example, 0.5 mol times or more, preferably 0.8 mol times or more, as the amount added in terms of sulfide ions with respect to the content of metal ions contained in the metal source constituting the mixture. The amount of the sulfur source added in terms of sulfide ions, for example, may be 3.0 mol times or less, or may be preferably 2.5 mol times or less or 2.0 mol times or less.

The sulfur source addition step may further include adjusting the pH of the mixture. The adjustment of the pH may be performed prior to the start of the addition of the sulfur source, or may be performed during the addition of the sulfur source. In addition, the adjustment of the pH may suppress fluctuations in the pH of the mixture accompanying the addition of the sulfur source. Specifically, the pH of the mixture can be adjusted by, for example, adding a basic compound or an acidic compound to the mixture. Examples of the basic compound used for pH adjustment include hydroxide salts such as hydroxides of alkali metals and hydroxides of alkaline earth metals, and aqueous ammonia solution. Examples of the acidic compound include nitric acid, sulfuric acid, phosphoric acid, and boric acid. The adjustment range of the pH in the adjustment of the pH, for example, may be in a range from 2 to 14, or may be preferably 2.5 or more. The adjustment of the pH may, for example, increase the pH of the mixture, preferably by 1 or more or 2 or more. In addition, the adjustment of the pH may be performed by, for example, lowering the pH of the mixture, preferably by 1 or more or 2 or more. Moreover, the adjustment of the pH may, for example, suppress fluctuations in the pH of the mixture, and the pH fluctuations accompanying the addition of the sulfur source may be suppressed to, for example, 13.5 or less, preferably 12 or less.

After the addition of the sulfur source, a deposition step of depositing the metal compound may be included. In the deposition step, the metal compound may be deposited while stirring the mixture, or the metal compound may be deposited in a stationary state. A temperature in the deposition step, for example, may be in a range from 0 °C to 100 °C, or may be preferably 10 °C or more or 90 °C or less. A deposition time in the deposition step, for example, may be in a range from 1 minute to 72 hours, or may be preferably 5 minutes or more or 48 hours or less.

The third manufacturing method may further include a separation step of separating the obtained first modified composite material from the mixture, and may further include a purification step, as necessary. In the separation step, for example, the first modified composite material may be taken out by subjecting the mixture containing the first modified composite material to solid-liquid separation. In the purification step, the first modified composite material may be washed with pure water or the like. The resultant first modified composite material may be dried by, for example, heat drying, vacuum degassing, air drying, or a combination thereof.

The third manufacturing method includes a second modification step of heat-treating the first modified composite material to obtain a second modified composite material in which a metal sulfide derived from the metal source is adhered to a composite material. Details of the second modification step in the third manufacturing method are the same as the second modification step in the first manufacturing method.

### Electrode Active Material for Lithium-Sulfur Battery

The electrode active material for a lithium-sulfur battery includes a composite material including a porous carbon material and sulfur supported on the porous carbon material, and a metal sulfide including a specific metal disposed on a surface of the composite material. In the positive electrode active material for a lithium-sulfur battery, a ratio Cx/Ci of a mass ratio Cx of the specific metal to a total amount of carbon, sulfur, oxygen, nitrogen, and the specific metal in the vicinity of a surface of the positive electrode active material for a lithium-sulfur battery measured by energy dispersive X-ray spectroscopy to a content ratio Ci of the specific metal on a mass basis in the positive electrode active material for a lithium-sulfur battery measured by inductively coupled plasma emission spectrometry is 0.3 or more. The specific metal may include at least one selected from the group consisting of Ti, V, Mn, Fe, Co, Ni, Cu, Zn, Ge, Zr, In, Sn, Nb, Mo, Ta, and W. Preferably, the specific metal may include at least Zn. That is, the metal sulfide may contain at least zinc sulfide.

The electrode active material for a lithium-sulfur battery may include a coated composite material in which at least a part of the surface of the composite material is coated with a metal sulfide, and the coated composite material may be, for example, the second modified composite material in the above-described manufacturing method. The metal sulfide is disposed on the surface of the composite material, so that the outflow of lithium polysulfide generated during charge and discharge of the lithium-sulfur battery from the porous carbon material can be more effectively suppressed. The presence of the metal sulfide can be detected by, for example, an X-ray diffraction (XRD) spectrum or a transmission electron microscope (TEM). For example, when the specific metal is zinc, the presence of ZnS can be confirmed by the presence of a peak derived from the (111) plane of ZnS around 28.5° in the XRD measurement. In addition, the (111) plane of ZnS can be assigned from a diffraction point in an electron beam diffraction image obtained by TEM observation.

In the electrode active material for a lithium-sulfur battery, the metal sulfide is disposed on the surface of the composite material. The arrangement state of the metal sulfide on the surface of the composite material can be evaluated by, for example, the ratio (hereinafter, also referred to as a dispersion index of the specific metal) of the content of the specific metal present in a partial region of the surface of the electrode active material for a lithium-sulfur battery to the total content of the specific metal contained in the electrode active material for a lithium-sulfur battery. As the value of the dispersion index is increased, the specific metal is more uniformly dispersed and present on the entire surface of the composite material.

The total content of the specific metal contained in the electrode active material for a lithium-sulfur battery can be evaluated as the content ratio Ci on a mass basis of the specific metal measured by inductively coupled plasma (ICP) emission spectrometry with respect to the positive electrode active material for a lithium-sulfur battery.

The contents of carbon, sulfur, oxygen, nitrogen, and a specific metal in the vicinity of the surface of the electrode active material for a lithium-sulfur battery containing the carbon, sulfur, and specific metal can be evaluated by an energy dispersive spectroscopy (EDX) method. That is, the content of the specific metal present on the surface of the electrode active material for a lithium-sulfur battery can be evaluated by the mass ratio Cx of the specific metal to the total mass of the carbon, oxygen, nitrogen, sulfur, and specific metal in the vicinity of the surface of the positive electrode active material for a lithium-sulfur battery measured by energy dispersive X-ray (EDX) spectroscopy. Regarding the measurement conditions of SEM-EDX, appropriate settings vary depending on the size of particles, but the magnification may be set such that at least 100 or more, preferably 500 or more, more preferably 1000 or more particles are present in an observation region. For example, when the D50 is about 2 μm, 1500 times can be selected as the magnification.

Here, the vicinity of the surface measured by the EDX spectroscopy has a varying depth depending on an element to be measured even under the same measurement conditions. For example, even in a measurement condition in which carbon, sulfur, or the like is detected up to a depth of several μm (10⁻⁶ m order), it is considered that a metal compound is detected only up to a depth of several hundred nm (10⁻⁷ m order). In this way, when the metal compound is localized with a certain thickness in the vicinity of the surface of the electrode active material for a lithium-sulfur battery, the content of a metal atom contained in the metal compound is detected as a content smaller than the content of carbon, sulfur, or the like. Accordingly, when the dispersion index Cx/Ci of the specific metal in the electrode active material for a lithium-sulfur battery is evaluated, the dispersion index Cx/Ci has a value close to 1 when the specific metal is uniformly distributed in the vicinity of the surface of the electrode active material for a lithium-sulfur battery. On the other hand, when the specific metal is localized in the vicinity of the surface of the electrode active material for a lithium-sulfur battery, the value is smaller than when the specific metal is uniformly distributed.

In the electrode active material for a lithium-sulfur battery, the dispersion index of the specific metal may be 0.3 or more, preferably 0.5 or more or 0.7 or more. In addition, the dispersion index of the specific metal may be 1.2 or less. When the dispersion index of the specific metal is within the above-described range, there is a tendency that the outflow of the lithium polysulfide generated during discharge of the lithium-sulfur battery from the porous carbon material can be more effectively suppressed. The dispersion index of the specific metal is evaluated as an arithmetic mean value of measured values measured for arbitrary three regions.

When the electrode active material for a lithium-sulfur battery contains zinc sulfide as the metal sulfide, in an X-ray diffraction (XRD) pattern, the intensity ratio of the intensity of a peak derived from a (220) plane to the intensity of a peak derived from the (111) plane of zinc sulfide may be 0.42 or more, preferably 0.421 or more or 0.422 or more. The intensity ratio of the peak may be 0.5 or less. When the intensity ratio of the peak in the XRD pattern is within the above-described range, the cycle retention rate tends to be further improved. The peak derived from the (111) plane of the zinc sulfide is observed around 28.5°, and the peak derived from the (220) plane is observed around 47.5°.

The content ratio of the specific metal contained in the electrode active material for a lithium-sulfur battery, for example, may be in a range from 0.1 mass % to 30 mass %, or may be 0.5 mass % or more or 20 mass % or less. In the electrode active material for a lithium-sulfur battery, the mass ratio of the content of the metal sulfide to the content of the composite material, for example, may be in a range from 0.15 mass % to 30 mass %, or may be 0.75 mass % or more or 40 mass % or less. Moreover, in the electrode active material for a lithium-ion battery, the mass ratio of the content of the metal sulfide to the total content of sulfur, for example, may be in a range from 0.2 mass % to 60 mass %, or may be 1 mass % or more or 30 mass % or less. When the content of the specific metal is within the above-described range, there is a tendency that the outflow of lithium polysulfide generated during discharge of the lithium-sulfur battery from the porous carbon material can be more effectively suppressed.

### Positive Electrode for Lithium-Sulfur Battery

A positive electrode for a lithium-sulfur battery (hereinafter, also simply referred to as “positive electrode”) includes a current collector and a positive electrode active material layer disposed on the current collector. The positive electrode active material layer may include the electrode active material for a lithium-sulfur battery described above. The positive electrode is manufactured, for example, by applying an electrode composition containing the electrode active material for a lithium-sulfur battery described above, a liquid medium, a binder, a conductive auxiliary agent, and the like onto the current collector, and then performing drying and pressure molding to form the positive electrode active material layer on the current collector.

As the liquid medium, an organic solvent, water, or the like may be used depending on the application. Examples of the organic solvent include amide-based solvents such as N-methyl-2-pyrrolidone (NMP), ketone-based solvents such as diisopropyl ketone, diisobutyl ketone, and methyl ethyl ketone, hydrocarbon-based solvents such as heptane, ether-based solvents such as tetrahydrofuran, dimethoxyethane, and dioxolane, amine-based solvents such as diethylenetriamine, and ester-based solvents. One type of the organic solvent may be used alone, or two or more types may be used in combination. The content ratio of the liquid medium may be, for example, in a range from 10 mass % to 90 mass % with respect to the total mass of the electrode composition.

The binder is, for example, a material that assists adhesion between the electrode active material and the conductive auxiliary agent and adhesion of the electrode composition to the current collector. Examples of the binder include polyvinylidene fluoride (PVDF), polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene rubber (EPDM), sulfonated EPDM, styrene-butylene rubber, fluorine rubber, and various copolymers. The content ratio of the binder may be, for example, in a range from 0.05 mass % to 50 mass % with respect to the total mass of the electrode composition.

The conductive auxiliary agent is, for example, a material that improves the electrical conductivity of the positive electrode composition layer. Examples of the conductive auxiliary agent include graphite such as modified graphene, natural graphite, and artificial graphite, carbon blacks such as acetylene black, ketjen black, channel black, furnace black, lamp black, and thermal black, conductive fibers such as carbon fibers and metal fibers, and carbon materials such as graphene and carbon nanotubes. The content ratio of the conductive auxiliary agent may be, for example, in a range from 0.5 mass % to 30 mass % with respect to the total mass of the electrode composition.

Examples of the current collector include metals such as copper, stainless steel, aluminum, nickel, and titanium, composite materials obtained by treating the surface of copper, stainless steel, or the like with carbon, nickel, titanium, silver, or the like, and carbon foils. When a lightweight lithium-sulfur battery is manufactured, for example, aluminum or carbon foil is preferable as a lightweight current collector. By forming fine irregularities on the surface of the current collector, the adhesive strength of the positive electrode composition layer and the like can also be increased. In addition, various forms such as a film, a sheet, a foil, a net, a porous body, a foamed body, and a nonwoven fabric body are possible. The thickness of the current collector may be in a range from 3 μm to 500 μm, for example.

The positive electrode active material layer formed by including the electrode active material for a lithium-sulfur battery as described above may be formed as a dense layer with few voids. The porosity of the positive electrode active material layer in the positive electrode, for example, may be 75% or less, or may be preferably 60% or less, 55% or less, or 50% or less. The lower limit of the porosity of the positive electrode active material layer may be 1% or more, for example. The porosity of the positive electrode active material layer may be calculated from the ratio between the theoretical density of the positive electrode composition layer calculated from the material constituting the positive electrode composition layer and the press density calculated from the thickness measured when the positive electrode composition layer is pressed. Alternatively, the porosity may be calculated by designating a predetermined range from a cross-sectional SEM image of the positive electrode active material layer and measuring the area ratio of a void portion with image analysis software.

### Lithium-Sulfur Secondary Battery

The lithium-sulfur battery includes the above-described positive electrode for a lithium-sulfur battery. The lithium-sulfur battery includes the positive electrode for a lithium-sulfur battery, a negative electrode, an electrolyte disposed between the positive electrode and the negative electrode, and the like. The lithium-sulfur battery may include a separator as necessary. The electrolyte may be included in the positive electrode, the negative electrode, and the separator for the lithium-sulfur battery.

### Negative Electrode

As the negative electrode constituting the lithium-sulfur battery, a known negative electrode may be used. Examples of a negative electrode material constituting the negative electrode include Li metal, Li—Si alloy, Li—Al alloy, Li—In alloy, lithium titanate (for example, Li₄Ti₅O₁₂ and LiTi₂O₄), lithium-titanium composite oxide (for example, Li₄Ti₅₋ₓMnₓO₁₂; 0<x≤0.3), and LiₓC (x≤6). In these negative electrode materials, a part of lithium may be substituted with another alkali metal. As the negative electrode material, Li metal, Li—Si alloy, Li—Al alloy, Li—In alloy, LiₓC (x≤6) or the like is preferable. With these materials, a high voltage can be taken out from the lithium-sulfur battery.

### Separator

As the separator, a known material may be used, and examples thereof include porous polyethylene and polypropylene. A known separator may also be coated and used.

### Electrolyte

The electrolyte may contain a lithium salt, and may be appropriately selected from lithium salts used in lithium-ion batteries in the related art. The lithium salt may contain, for example, an anion having a fluorine element. Specific examples of the lithium salt containing an anion having a fluorine element include LiPF₆, LiBF₄, LiSbF₆, LiAsF₆, LiSO₃CF₃, and LiN(SO₂CF₃)₂(LiTFSI), and LiN(SO₂F)₂(LiFSI). The electrolyte may contain a lithium salt containing no fluorine element such as lithium nitrate or LiClO₄. As the electrolyte, one of the specific examples can be used alone, or a combination of two or more types thereof can be used.

The electrolyte may contain an organic solvent. As the organic solvent, a carbonate-based solvent, an ether-based solvent, an ester-based solvent, an amide-based solvent, a nitrile-based solvent, or a sulfur-containing solvent may be used, or an organic solvent obtained by substituting a part of the elements of the above-described organic solvent with fluorine may be used. Examples of the organic solvent include carbonate-based solvents such as propionic carbonate, ethylene carbonate, dimethyl carbonate, ethylmethyl carbonate, and fluoroethylene carbonate, ether-based solvents such as 1,3-dioxolane, 1,2-dimethoxyethane, 1,3-dimethoxypropane, 2,2,3,3-tetrafluoropropyl difluoromethyl ether, and tetrahydrofuran, ester-based solvents such as methyl formate, methyl acetate, and γ-butyrolactone, amide-based solvents such as N,N-dimethylacetamide and N,N-dimethylformamide, and sulfur-containing solvents such as sulfolane, dimethyl sulfoxide, and 1,3-propanesultone.

As another aspect, the invention according to the present disclosure includes use of the electrode active material for a lithium-sulfur battery in manufacturing a positive electrode for a lithium-sulfur battery or a lithium-sulfur battery, and an electrode active material for a lithium-sulfur battery used in manufacturing a positive electrode for a lithium-sulfur battery or a lithium-sulfur battery.

The invention according to the present disclosure may include, for example, the following aspects.

[1] A method for manufacturing an electrode active material for a lithium-sulfur battery, the method comprising:
obtaining a first modified composite material by mixing a composite material including a porous carbon material and sulfur supported on the porous carbon material, a metal source, and a liquid medium, the first modified composite material having a metal compound derived from the metal source being adhered to the first modified composite material; and
obtaining a second modified composite material by heat-treating the first modified composite material, the second modified composite material having a metal sulfide derived from the metal source being adhered to the second modified composite material,
wherein the metal source comprises at least one specific metal selected from the group consisting of Ti, V, Mn, Fe, Co, Ni, Cu, Zn, Ge, Zr, In, Sn, Nb, Mo, Ta, and W.

[2] The method for manufacturing an electrode active material for a lithium-sulfur battery according to [1], wherein obtaining the first modified composite material comprises heat-treating a mixture containing the composite material, the metal source, and the liquid medium under pressure to deposit the metal compound on a surface of the composite material.

[3] The method for manufacturing an electrode active material for a lithium-sulfur battery according to [2], wherein the heat-treating under pressure is performed at a temperature equal to or higher than a boiling point of the liquid medium.

[4] The method for manufacturing an electrode active material for a lithium-sulfur battery according to any one of [2] or [3], wherein the heat-treating under pressure is performed in a closed system.

[5] The method for manufacturing an electrode active material for a lithium-sulfur battery according to [1], wherein obtaining the first modified composite material comprises adjusting a pH of a mixture containing the composite material, the metal source, and the liquid medium to deposit the metal compound on a surface of the composite material.

[6] The method for manufacturing an electrode active material for a lithium-sulfur battery according to [1], wherein obtaining the first modified composite material comprises adding a sulfur source to a mixture containing the composite material, the metal source, and the liquid medium to deposit the metal compound on a surface of the composite material.

[7] The method for manufacturing an electrode active material for a lithium-sulfur battery according to [6], wherein obtaining the first modified composite material further comprises adjusting a pH of the mixture.

[8] The method for manufacturing an electrode active material for a lithium-sulfur battery according to any one of [1] to [7], wherein the porous carbon material has a peak pore size in a range from 0.5 nm to 10 nm.

[9] The method for manufacturing an electrode active material for a lithium-sulfur battery according to any one of [1] to [8], wherein the porous carbon material has a volume mean particle size in a range from 0.5 μm to 20 μm.

[10] The method for manufacturing an electrode active material for a lithium-sulfur battery according to any one of [1] to [9], wherein the porous carbon material has an aspect ratio in a range from 1 to 3.

[11] The method for manufacturing an electrode active material for a lithium-sulfur battery any one of [1] to [10], wherein the heat-treating of the first modified composite material comprises removing at least a part of the liquid medium to obtain a dried product.

[12] The method for manufacturing an electrode active material for a lithium-sulfur battery according to [11], wherein the heat-treating of the first modified composite material further comprises heat-treating the dried product in a range from 50 °C to 400 °C.

[13] A positive electrode active material for a lithium-sulfur battery, comprising a porous carbon material, sulfur supported on the porous carbon material, and a metal sulfide including a specific metal,
wherein a ratio of: a mass ratio of the specific metal to a total amount of carbon, sulfur, oxygen, nitrogen, and the specific metal in a vicinity of a surface of the positive electrode active material for a lithium-sulfur battery as measured by X-ray photoelectron spectroscopy; to a content ratio of the specific metal on a mass basis in the positive electrode active material for a lithium-sulfur battery as measured by inductively coupled plasma emission spectrometry is 0.3 or more, and
the specific metal comprises at least one selected from the group consisting of Ti, V, Mn, Fe, Co, Ni, Cu, Zn, Ge, Zr, In, Sn, Nb, Mo, Ta, and W.

[14] The electrode active material for a lithium-sulfur battery according to [13], wherein the porous carbon material has a peak pore size in a range from 0.5 nm to 10 nm.

[15] The electrode active material for a lithium-sulfur battery according to or [14], wherein the porous carbon material has a volume mean particle size in a range from 0.5 μm to 20 μm.

[16] The electrode active material for a lithium-sulfur battery according to any one of [13] to [15], wherein the porous carbon material has an aspect ratio in a range from 1 to 3.

[17] The positive electrode active material for a lithium-sulfur battery according to any one of [13] to [16], wherein the ratio of: the mass ratio of the specific metal to the total amount of carbon, sulfur, oxygen, nitrogen, and the specific metal in the vicinity of the surface of the positive electrode active material for a lithium-sulfur battery as measured by X-ray photoelectron spectroscopy; to the content ratio of the specific metal on a mass basis in the positive electrode active material for a lithium-sulfur battery as measured by inductively coupled plasma emission spectrometry is 0.5 or more.

[18] The positive electrode active material for a lithium-sulfur battery according to [17], wherein the ratio of: the mass ratio of the specific metal to the total amount of carbon, sulfur, oxygen, nitrogen, and the specific metal in the vicinity of the surface of the positive electrode active material for a lithium-sulfur battery as measured by X-ray photoelectron spectroscopy; to the content ratio of the specific metal on a mass basis in the positive electrode active material for a lithium-sulfur battery as measured by inductively coupled plasma emission spectrometry is 0.7 or more.

[19] The positive electrode active material for a lithium-sulfur battery according to any one of [13] to [18], wherein the metal sulfide comprises zinc sulfide.

[20] The positive electrode active material for a lithium-sulfur battery according to any one of [13] to [19], wherein the positive electrode active material for a lithium-sulfur battery has, in an X-ray diffraction pattern, an intensity ratio of a peak derived from a (220) plane to a peak derived from a (111) plane of zinc sulfide of 0.42 or more.

[21] The positive electrode active material for a lithium-sulfur battery according to any one of [13] to [20], wherein a content ratio of the specific metal in the positive electrode active material for a lithium-sulfur battery is in a range from 0.1 mass % to 20 mass %.

### EXAMPLES

The present invention is specifically described below through examples; however, the present invention is not limited to these examples.

### Example 1

### Manufacturing of ZnS-Containing Sulfur-Carbon Positive Electrode Active Material

A mixture was obtained by mixing a porous carbon material (available from AT Electrode Co., Ltd., AP20-0001HC) 12 g and a sulfur powder 18 g (at a weight ratio of 40:60). The obtained mixture was placed in a pressure-resistant container and heat-treated at 150 °C for 3 hours to obtain a composite material as a sulfur-carbon composite. The physical properties of the porous carbon material used are presented in Table 1 below. Measurement of nitrogen adsorption isotherm, BET specific surface area, and analysis of pore size distribution by the quenched solid density functional method (QSDFT method) were performed using “Novatouch” available from Quantachrome Instruments. An aspect ratio was also calculated as follows.

### Calculation of Aspect Ratio

The porous carbon material before sulfur-impregnation was mounted on a carbon tape, and the shape of the porous carbon material was observed using an electronic microscope (available from Hitachi High-Technologies Corporation, FLEXSEM1000II). The observation was performed at an accelerating voltage of 5 kV and a magnification of 10000 times. For arbitrary particles whose particle shape can be confirmed (47 particles in which the arithmetic average of a major axis and a minor axis is 0.1 times to 1.5 times D50 in the appearance observed by SEM), the aspect ratio was calculated using Image J, and the average value thereof was calculated. As a result, the aspect ratio was 1.15.

### Measurement of Particle Size Distribution

A volume-based particle size distribution was measured using a laser diffraction particle size distribution device (available from Malvern Instruments, MASTERSIZER 2000). A measurement sample was prepared by dispersing an appropriate amount of carbon material in an ethanol solvent 170 mL so that the laser intensity of the measuring device is within an appropriate range. A stirring process was performed at 2500 rpm for 60 seconds. The volume mean particle size was calculated as a 50% particle size D₅₀ at which a volume integrated value from a small particle size side in a volume-based particle size distribution is 50%. In addition, a 10% particle size D₁₀ and a 90% particle size D₉₀ were calculated as values at which the volume integrated values from the small particle size side were 10% and 90%, respectively. The results are presented in Table 1 below.

TABLE 1

| | Total | Peak | | | | |
|---|---|---|---|---|---|---|
| Specific | pore | pore | | | | |
| surface | volume | size | Particle size distribution | | | Aspect |
| area | (ml/g) | (nm) | D₁₀ (mm) | D₅₀ (mm) | D₉₀ (mm) | ratio |
| 1928 | 0.99 | 2.7 | 0.9 | 2 | 6.3 | 1.15 |

The composite material 4 g was mixed with zinc oxide 0.3 g. Pure water 8 g was added to the mixture of the zinc oxide and the composite material and mixed to obtain a slurry as a dispersion of the zinc oxide and the composite material. The obtained slurry was placed in a pressure-resistant container and heat-treated at 230 °C for 3 hours in a closed system. The heat-treated slurry was subjected to suction filtration, and the filtration product was dried at 50 °C for 30 minutes to obtain a dried product. The above-described dried product was placed in a closed container and heat-treated at 300 °C for 3 hours to obtain a ZnS-containing sulfur-carbon positive electrode active material of Example 1 as a coated composite material.

### Example 2

A ZnS-containing sulfur-carbon positive electrode active material of Example 2 was produced in the same manner as in Example 1 except that the amount of zinc oxide added to the mixture was changed to 0.15 g.

### Example 3

A ZnS-containing sulfur-carbon positive electrode active material of Example 3 was produced in the same manner as in Example 1 except that the amount of zinc oxide added to the mixture was changed to 0.6 g.

### Example 4

Zinc sulfate heptahydrate (Fujifilm Wako Pure Chemical Industries, Ltd.) 1.05 g was added with pure water 36 g to obtain a zinc sulfate aqueous solution. The composite material 4.0 g was mixed with the obtained solution to obtain a dispersion slurry. Sodium hydroxide (Fujifilm Wako Pure Chemical Industries, Ltd.) 0.58 g was added with pure water 40 g and dissolved to obtain an aqueous sodium hydroxide solution. The aqueous sodium hydroxide solution was added to the dispersion slurry obtained as described above and stirred for 10 minutes. The pH of the slurry was 12.8 to 12.9. After the stirring, the slurry was subjected to suction filtration, and the filtration product was heated at 50 °C for 30 minutes to obtain a dried product. The vapor-dried product was placed in a sealed heating and heat-treated at 300 °C for 3 hours to obtain a ZnS-containing sulfur-carbon positive electrode material of Example 4 as a coated composite material.

### Comparative Example 1: Manufacturing of Sulfur-Carbon Positive Electrode Active Material

A porous carbon material (available from AT Electrode Co., Ltd., AP20-0001HC) 12 g and a sulfur powder 18 g (at a weight ratio of 40:60) were mixed. The mixture of the porous carbon material and the sulfur powder was placed in a pressure-resistant container and heat-treated at 150 °C for 3 hours. Subsequently, the temperature was returned to room temperature, and the mixture was heat-treated at 350 °C for 3 hours to obtain a sulfur-carbon positive electrode active material of Comparative Example 1.

### Comparative Example 2

A composite material was obtained as a sulfur-carbon composite in the same manner as in Example 1. The obtained composite material 4.0 g and zinc sulfide (Kishida Chemical Co., Ltd.) 0.36 g were mixed, placed in a closed container, and heat-treated at 300 °C for 3 hours to obtain a ZnS-containing sulfur-carbon positive electrode active material of Comparative Example 2.

### X-Ray Diffraction (XRD) Analysis

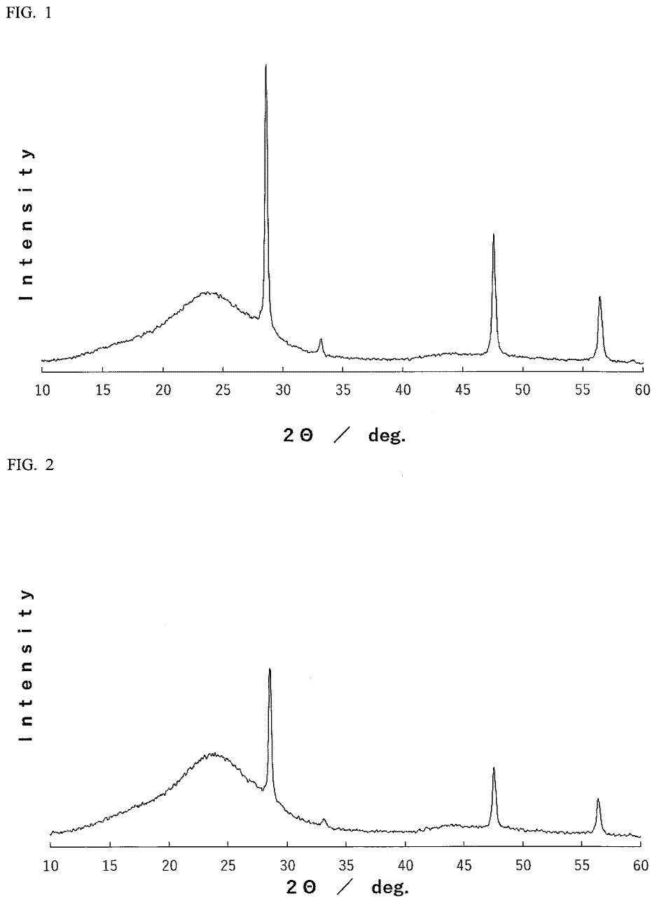

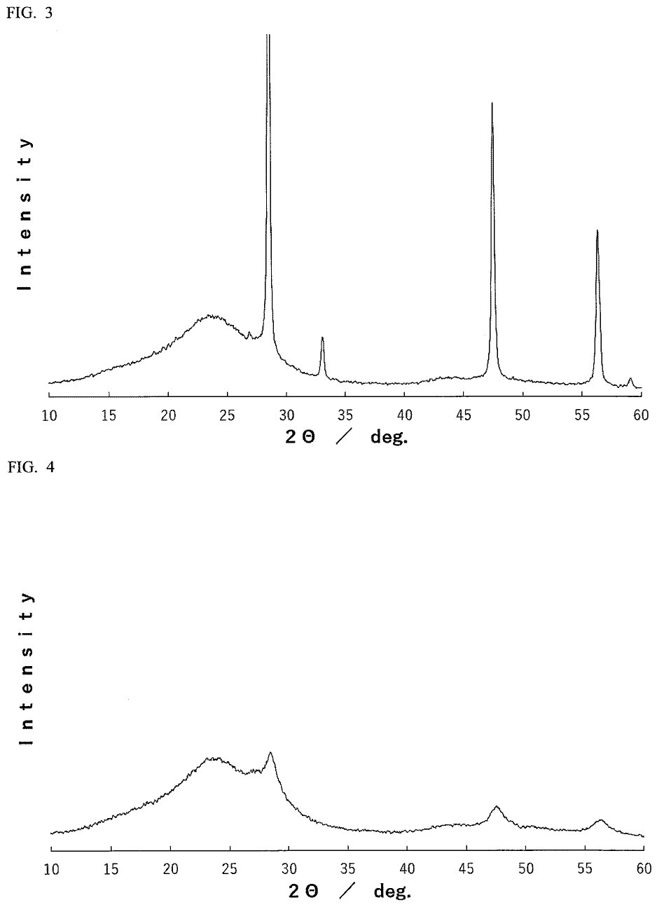

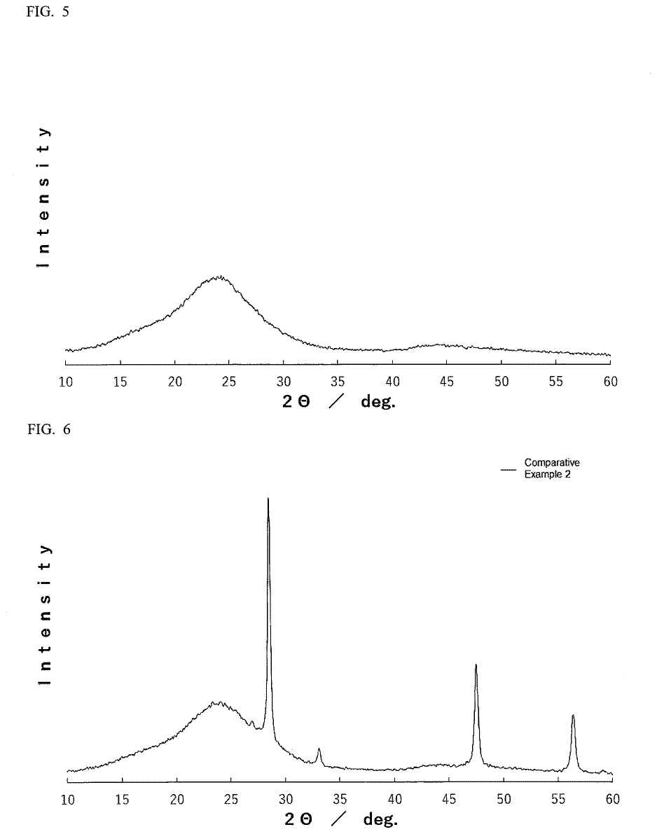

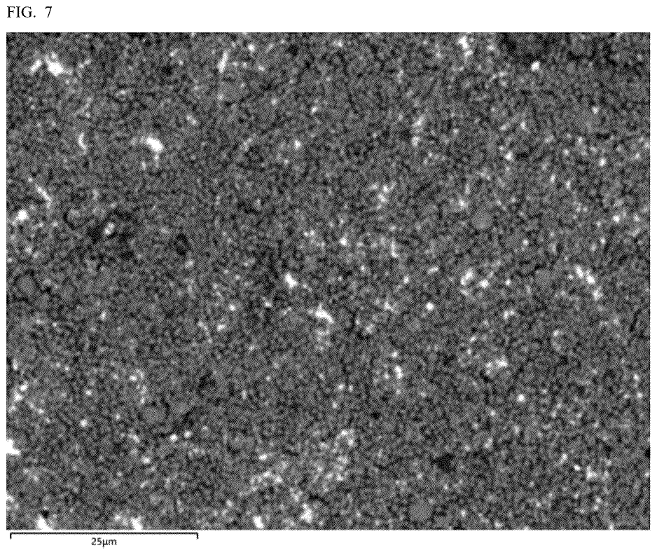

The ZnS-containing sulfur-carbon positive electrode active materials manufactured in Example 1, Example 2, Example 3, Example 4, Comparative Example 1, and Comparative Example 2 were subjected to XRD analysis (by miniflex available from Rigaku Corporation). FIGS. 1 to 4 illustrate the XRD analysis results of the ZnS-containing sulfur-carbon positive electrode active materials manufactured in examples 1 to 4. FIG. 5 illustrates the XRD analysis results of the sulfur-carbon positive electrode active material of Comparative Example 1, and FIG. 6 illustrates the XRD analysis results of the positive electrode active material of Comparative Example 2.

In FIG. 1, since a peak derived from the (111) plane of ZnS can be confirmed around 28.5°, it was confirmed that crystalline ZnS was formed in the sulfur-carbon positive electrode active material added with ZnS manufactured in Example 1. In addition, a peak derived from the (220) plane of ZnS was also confirmed around 47.5°. Moreover, a peak derived from the (311) plane of ZnS was also confirmed around 56.5°.

### ICP Analysis

The content ratio Ci on a mass basis of Zn, which is a specific metal contained in the positive electrode active material, was calculated by inductively coupled plasma (ICP) emission spectral analysis of the positive electrode active material obtained above. Specifically, a sample was produced using nitric acid and heated and dissolved using microwaves, and the content of Zn was calculated using an inductively coupled plasma (ICP) emission spectrometer (ICP-AES; Optima8300: available from Perkin Elmer Corporation). The results are presented in Table 2 below.

### Surface Composition Analysis

Using a scanning electron microscope (SEM)/energy dispersive X-ray analyzer (EDX) (available from Hitachi High-Technologies Corporation; accelerating voltage 5 kV, magnification 1500 times, the number of counts in spectral area >2500000), the ratio Cx of zinc to the total amount of carbon, sulfur, oxygen, nitrogen, and zinc in the vicinity of the surface of the positive electrode active material was calculated at three locations, and the arithmetic mean thereof was calculated. Moreover, Cx/Ci was calculated as the dispersion index of the specific metal. The results are presented in Table 2 below. FIG. 7 illustrates an SEM image used for the EDX analysis of Example 1.

Manufacturing of Positive Electrode for Lithium-Sulfur Secondary Battery A positive electrode slurry composition was produced by mixing 85 parts by mass of the sulfur-carbon positive electrode active material manufactured in Example 1 and Comparative Example 1, 10 parts by mass of carbon black, and 5 parts by mass of styrene-butadiene rubber (SBR)/carboxymethylcellulose (CMC)/polyvinylpyrrolidone (PVP) (SBR/CMC/PVP=2.0/2.5/0.5).

The obtained positive electrode slurry composition was applied to a current collector and dried at 50 °C for 30 minutes. An aluminum foil coated with carbon was used as the current collector. The dried product was pressed by a roll press machine so that the density of the active material layer is 1.0 g/cm³, and then cut into a predetermined size to obtain the positive electrode for a lithium-sulfur secondary battery of Example 1.

Production of Nonaqueous Electrolytic Solution Fluoroethylene carbonate (FEC) and dimethyl carbonate (DMC) were mixed at a volume ratio of 71:100 to obtain a mixed solution. Lithium hexafluorophosphate (LiPF₆) was dissolved in the obtained mixed solution at a concentration of 1.0 mol/L to produce a nonaqueous electrolytic solution.

### Assembly of Lithium-Sulfur Secondary Battery

A lead electrode was attached to the positive electrode obtained above, a separator made of porous polypropylene (Celgard 2400) was disposed the positive electrode, and the resultant was housed in a bag-shaped laminate pack. Subsequently, the resultant was vacuum-dried at 50 °C to remove moisture adsorbed on each member. After the vacuum drying, the metal lithium of the negative electrode disposed on the SUS foil was disposed in the laminate pack to face the positive electrode via porous polypropylene, and the nonaqueous electrolytic solution produced as described above was injected and sealed to obtain a laminate type lithium-sulfur secondary battery as a battery for evaluation. The obtained battery for evaluation was used to evaluate the following battery characteristics.

### Evaluation of Charge-Discharge Cycle Capacity Retention Rate

The battery for evaluation obtained as described above was installed in a thermostatic chamber at 25 °C, and an evaluation test of the cycle capacity retention rate was performed. The charge/discharge voltage was in the range of 1.0 V to 3.0 V. As the discharge current, a current value at the time of taking out the 0.1 C capacity was caused to flow. A discharge capacity Qcyc (2) per mass of sulfur in the second cycle immediately after the start of discharge was measured. Subsequently, charge and discharge were repeated, and a discharge capacity Qcyc (30) at the 30th cycle was measured. The capacity retention rate Pcyc (=100 xQcyc (30)/Qcyc (2)) (%) after 30 cycles was calculated by dividing Qcyc (30) by the obtained Qcyc (2). The results are presented in Table 2 below.

TABLE 2

| | XRD analysis | | | | | | |
|---|---|---|---|---|---|---|---|
| | | Peak | | | | | |
| | | intensity | | | | | Dispersion |
| | ZnS peak | ratio | Qcyc(2) | Pcyc | | | index |
| | (111) | (220)/(111) | (mAh/Sg) | (%) | Ci | Cx | (Cx/Ci) |
| Example 1 | Present | 0.450 | 900.8 | 67.7 | 5.7 | 5.24 | 0.92 |
| Example 2 | Present | 0.443 | 957.2 | 66.3 | 2.9 | 3.14 | 1.08 |
| Example 3 | Present | 0.450 | 841.2 | 70.6 | 10.4 | 7.70 | 0.74 |
| Example 4 | Present | 0.423 | 878.5 | 66.2 | 6.1 | 4.99 | 0.82 |
| Comparative Example 1 | Absent | — | 937.0 | 65.2 | — | — | — |
| Comparative Example 2 | Present | 0.412 | 969.5 | 63.7 | 5.9 | 1.69 | 0.29 |

In the batteries for evaluation including the ZnS-containing sulfur-carbon positive electrode active materials of Example 1 to Example 4, the cycle performance was improved as compared with Comparative Example 1. In Comparative Example 2, the cycle performance was deteriorated. This is considered to be because the dispersion index was low and ZnS was segregated, so that the effect of suppressing a side reaction between sulfur and the electrolytic solution by the coating was not sufficiently obtained. In Example 1 to Example 4, the peak intensity ratio (220/111) of ZnS was higher than the peak intensity ratio of Comparative Examples. When (220/111) is low, it is considered that the occupancy of the S site in ZnS is low and an S defect exists in the structure. Therefore, it is considered that the crystal structure of ZnS was destabilized when charge and discharge were repeated and the cycle performance was deteriorated.

The disclosure of Japanese Patent Application No. 2023-050319 (Filing date: Mar. 27, 2023) is incorporated herein by reference in its entirety. All publications, patent applications, and technical standards described in the present specification are incorporated herein by reference to the same extent as a case in which the incorporation by reference of each individual publication, patent application, and technical standard is specifically and individually indicated to be incorporated by reference.

What is claimed is:

1. A method for manufacturing an electrode active material for a lithium-sulfur battery, the method comprising:
obtaining a first modified composite material by a procedure comprising mixing a composite material including a porous carbon material and sulfur supported on the porous carbon material, a metal source, and a liquid medium, the first modified composite material having a metal compound derived from the metal source being adhered to the first modified composite material; and
obtaining a second modified composite material by heat-treating the first modified composite material, the second modified composite material having a metal sulfide derived from the metal source being adhered to the second modified composite material,
wherein the metal source comprises at least one metal selected from the group consisting of Ti, V, Mn, Fe, Co, Ni, Cu, Zn, Ge, Zr, In, Sn, Nb, Mo, Ta, and W.

2. The method for manufacturing an electrode active material for a lithium-sulfur battery according to claim 1, wherein obtaining the first modified composite material comprises heat-treating under pressure a mixture containing the composite material, the metal source, and the liquid medium to deposit the metal compound on a surface of the composite material.

3. The method for manufacturing an electrode active material for a lithium-sulfur battery according to claim 2, wherein the heat-treating under pressure is performed at a temperature equal to or higher than a boiling point of the liquid medium.

4. The method for manufacturing an electrode active material for a lithium-sulfur battery according to claim 2, wherein the heat-treating under pressure is performed in a closed system.

5. The method for manufacturing an electrode active material for a lithium-sulfur battery according to claim 1, wherein obtaining the first modified composite material comprises adjusting a pH of a mixture containing the composite material, the metal source, and the liquid medium to deposit the metal compound on a surface of the composite material.

6. The method for manufacturing an electrode active material for a lithium-sulfur battery according to claim 1, wherein obtaining the first modified composite material comprises adding a sulfur source to a mixture containing the composite material, the metal source, and the liquid medium to deposit the metal compound on a surface of the composite material.

7. The method for manufacturing an electrode active material for a lithium-sulfur battery according to claim 6, wherein obtaining the first modified composite material further comprises adjusting a pH of the mixture.

8. The method for manufacturing an electrode active material for a lithium-sulfur battery according to claim 1, wherein the porous carbon material has a peak pore size in a range of 0.5 nm to 10 nm.

9. The method for manufacturing an electrode active material for a lithium-sulfur battery according to claim 1, wherein the porous carbon material has a volume mean particle size in a range of 0.5 μm to 20 μm.

10. The method for manufacturing an electrode active material for a lithium-sulfur battery according to claim 1, wherein the porous carbon material has an aspect ratio in a range of 1 to 3.

11. The method for manufacturing an electrode active material for a lithium-sulfur battery according to claim 1, wherein the heat-treating of the first modified composite material comprises removing at least a part of the liquid medium to obtain a dried product.

12. The method for manufacturing an electrode active material for a lithium-sulfur battery according to claim 11, wherein the heat-treating of the first modified composite material further comprises heat-treating the dried product in a range of 50 °C to 400 °C.

13. An electrode active material for a lithium-sulfur battery, comprising a porous carbon material, sulfur supported on the porous carbon material, and a metal sulfide including a metal,
wherein a ratio of: a mass ratio of the metal to a total amount of carbon, sulfur, oxygen, nitrogen, and the metal in a vicinity of a surface of the electrode active material for a lithium-sulfur battery as measured by X-ray photoelectron spectroscopy; to a content ratio of the metal on a mass basis in the electrode active material for a lithium-sulfur battery as measured by inductively coupled plasma emission spectrometry is 0.3 or more, and
wherein the metal comprises at least one selected from the group consisting of Ti, V, Mn, Fe, Co, Ni, Cu, Zn, Ge, Zr, In, Sn, Nb, Mo, Ta, and W.

14. The electrode active material for a lithium-sulfur battery according to claim 13, wherein the porous carbon material has a peak pore size in a range of 0.5 nm to 10 nm.

15. The electrode active material for a lithium-sulfur battery according to claim 13, wherein the porous carbon material has a volume mean particle size in a range of 0.5 μm to 20 μm.

16. The electrode active material for a lithium-sulfur battery according to claim 13, wherein the porous carbon material has an aspect ratio in a range of 1 to 3.

17. The electrode active material for a lithium-sulfur battery according to claim 13, wherein the ratio of: the mass ratio of the metal to the total amount of carbon, sulfur, oxygen, nitrogen, and the metal in the vicinity of the surface of the electrode active material for a lithium-sulfur battery as measured by X-ray photoelectron spectroscopy; to the content ratio of the metal on a mass basis in the electrode active material for a lithium-sulfur battery as measured by inductively coupled plasma emission spectrometry is 0.5 or more.

18. The electrode active material for a lithium-sulfur battery according to claim 17, wherein the ratio of: the mass ratio of the metal to the total amount of carbon, sulfur, oxygen, nitrogen, and the metal in the vicinity of the surface of the electrode active material for a lithium-sulfur battery as measured by X-ray photoelectron spectroscopy; to the content ratio of the metal on a mass basis in the electrode active material for a lithium-sulfur battery as measured by inductively coupled plasma emission spectrometry is 0.7 or more.

19. The electrode active material for a lithium-sulfur battery according to claim 13, wherein the metal sulfide comprises zinc sulfide.

20. The electrode active material for a lithium-sulfur battery according to claim 19, wherein the electrode active material for a lithium-sulfur battery has, in an X-ray diffraction pattern, an intensity ratio of a peak derived from a (220) plane to a peak derived from a (111) plane of zinc sulfide that is 0.42 or more.

21. The electrode active material for a lithium-sulfur battery according to claim 13, wherein a content ratio of the metal in the electrode active material for a lithium-sulfur battery is in a range of 0.1 mass % to 20 mass %.
